(19) United States
(12) Patent Application Publication
(10) Pub. No.: US 2009/0258246 A1
(43) Pub. Date: Oct. 15, 2009

(54) PLASTIC HOUSING AND METHOD FOR MAKING THE SAME

(75) Inventors: JUAN-RONG WU, Shenzhen City (CN); ZHI-ZHONG XIAO, Shenzhen City (CN); PO-FENG HO, Shindian (TW); BO ZHANG, Shenzhen City (CN); GUAN-QUN ZENG, Shenzhen City (CN); GUO-YONG LI, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/412,514

(22) Filed: Mar. 27, 2009

(30) Foreign Application Priority Data
Apr. 10, 2008 (CN) 200810300940.7

(51) Int. Cl. B32B 15/08; C25D 5/00; B32B 3/10

(52) U.S. Cl. 428/614; 205/183

(57) ABSTRACT

A plastic housing includes a substrate, an activating metal coating made of noble metal, a chemical metal coating deposited on the activating metal coating, an oxidized metal film formed on and partially covering the chemical metal coating, an electroplated metal coating formed on a portion of the chemical metal coating not covered by the oxidized metal film, and a patterned ink coating formed on the oxidized metal film. The patterned ink coating is recessed relative to the electroplated metal coating.

### BACKGROUND OF THE INVENTION

1. Field of the Invention

The present invention relates to a method for making plastic housings.

2. Discussion of the Related Art

Electroplating is an attractive and effective process for improving corrosion resistance and metallic appearance of covers. Many covers for mobile devices are processed to form plated metal coatings on surfaces thereof using electronic plating.

Designs as such pictures or patterns are typically made by printing ink on the covers. However, ink poorly adheses to plated metal coatings, thus ink can be worn away.

Therefore, there is room for improvement within the art.

### BRIEF DESCRIPTION OF THE DRAWINGS

Many aspects of the plastic housing can be better understood with reference to the following drawing. The components in the drawing are not necessarily to scale, the emphasis instead being placed upon clearly illustrating the principles of the present plastic housing. Moreover, in the drawing, like reference numerals designate corresponding parts throughout the following view.

FIG. 1 is a section view of an exemplary embodiment of the present plastic housing.

FIG. 2 is a flow chart of an exemplary embodiment of a method for making the present plastic housing.

### DETAILED DESCRIPTION OF THE EMBODIMENTS

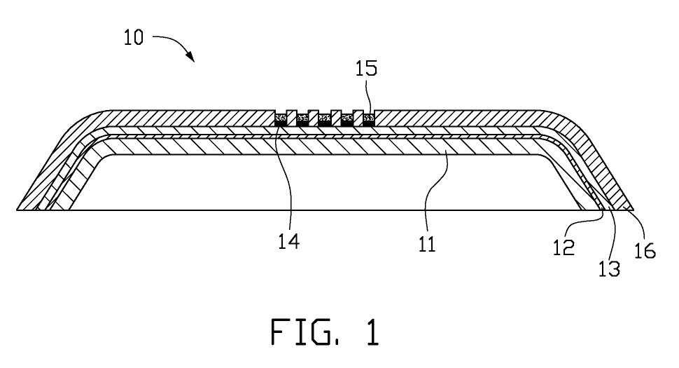

Referring to the FIG. 1, a plastic housing 10 of an exemplary embodiment includes a substrate 11, an activating metal coating 12 made of noble metal, a chemical metal coating 13 bridgedly deposited on the activating metal coating 12, an oxidized metal film 14 and an electroplated metal coating 16 both formed on the chemical metal coating 13, and a patterned ink coating 15 formed on the oxidized metal film 14. The substrate 11 may be made of material selected from the group consisting of acrylonitrile butadiene styrene (ABS), polymethyl methacrylate (PMMA), and polycarbonate (PC). The oxidized metal film 14 may be formed by oxidizing the chemical metal coating 13, but does not completely cover the chemical metal coating 13. The electroplated metal coating 16 is formed on a portion of the chemical metal coating 13 not covered by the oxidized metal film 14.

The patterned ink coating 15 may be applied by a printing process, preferably by screen printing, to display designs such as patterns, pictures and writing. The patterned ink coating 15 should preferably involve an acid-resistant, alkali-resistant and non-conductive resin system. The patterned ink coating 15 can be recessed relative to the electroplated metal coating 16, thereby decreasing the opportunity for scratching the patterned ink coating 15 when using the plastic housing 10.

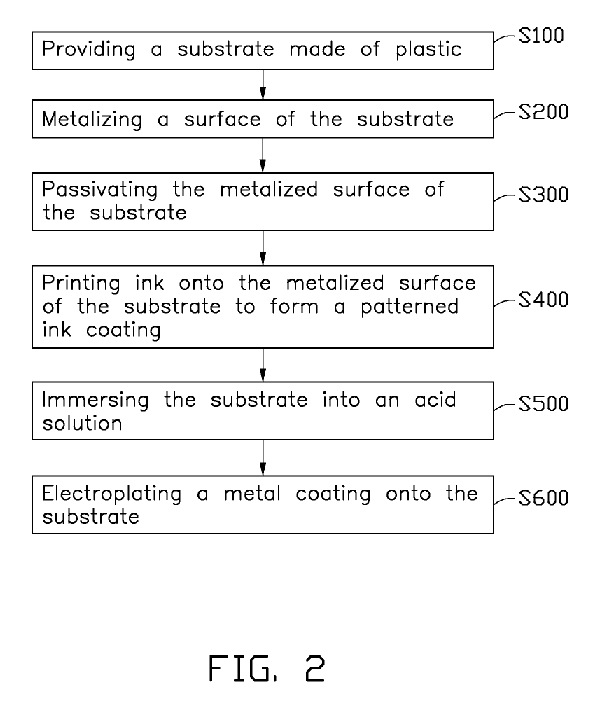

Referring to the FIG. 2, a method for making the plastic housing 10 may include steps S100 to S600.

In step S100, a substrate 11 made from a plastic selected from the group consisting of acrylonitrile butadiene styrene (ABS), poly methyl methacrylate (PMMA), and polycarbonate (PC) is provided.

In step S200, a surface of the substrate 11 is metalized by wet chemical deposition. During the wet chemical deposition, the surface of the substrate 11 to be metalized is first roughened by etching. The etching of the substrate 11 allows an activating layer 12 to be attached onto the roughened plastic surface in a subsequent process. The etching process may be carried out, for example, using chromic acid, chromosulfuric acid, or potassium permanganate etching solution. It is, of course, to be understood that the etching process also can be carried out in a plasma chamber. An associated cleaning step cleans the substrate 11. Subsequently, the surface of the substrate 11 is activated by immersion into an activating solution containing hydrochloric acid, polyamide acid, and noble metal salt. During activation, a noble metal is separated out from the activating solution, then dispersed and deposited the surface of the substrate 11 to form an activating metal coating 12 on to the roughened surface of the substrate 11. The noble metal salt may include palladium salt. After activation, the substrate 11 is rinsed and then metalized with chemical plating in a copper electrolyte containing copper salt and sulfuric acid, thereby depositing a chemical metal coating 13 formed of copper on the substrate 11. The chemical metal coating 13 may be bridged over the activating metal coating 12.

In step S300, the metalized surface is passivated in a passivating solution containing nitric acid or chromic acid. That is, the chemical metal coating 13 is oxidized to form an oxidized metal film 14 coated thereon, which may protect the chemical metal coating 13 from being corroded in moisture.

In step S400, a patterned ink coating 15 is printed on at least one portion of the oxidized metal film 14 by a screen printing process, so that the patterned ink coating 15 partially covers the oxidized metal film 14. The covered portion of the oxidized metal film 14 by the patterned ink coating 15 can be protected from being removed away in a subsequent acid cleaning process. The patterned ink coating 15 preferably should involve an acid-resistant, alkali-resistant and non-conductive resin system.

In step S500, the substrate 11 is immersed into an acid solution such as hydrochloric acid. A portion of the oxidized metal film 14 not covered by the patterned ink coating 15 is removed from the substrate 11 by reacting with the acid solution, thereby partially exposing the chemical metal coating 13. Another portion of the oxidized metal film 14 covered by the patterned ink coating 15 remains on the chemical metal coating 13 and has better adhesion to the patterned ink coating 15 than that of the chemical metal coating 13.

In step S600, after partially exposing the chemical metal coating 13, a metal coating 16 is electroplated on the chemical metal coating 13. The electroplated metal coating 16 includes at least one of a copper coating, a chrome coating, and a steel coating. The thickness of the electroplated metal coating 16 increases as the electroplating process proceeds, thus the electroplated metal coating 16 with a desired thickness larger than that of the patterned ink coating 15 can be obtained by controlling the length of time over which the electroplating process takes place. The patterned ink coating formed of ink is a non-conductive resin system, thereby not being coated in the electroplating process. Therefore, the patterned ink coating 15 is recessed relative to the electroplated metal coating 16.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A plastic housing, comprising:
a substrate;
an activating metal coating made of noble metal;
a chemical metal coating deposited on the activating metal coating;
an oxidized metal film formed on a portion of the chemical metal coating;
an electroplated metal coating formed on another portion of the chemical metal coating; and
a patterned ink coating formed on the oxidized metal film and recessed relative to the electroplated metal coating.

2. The plastic housing as claimed in claim 1, wherein the substrate is made of plastic selected from the group consisting of acrylonitrile butadiene styrene, poly methyl methacrylate, and polycarbonate.

3. The plastic housing as claimed in claim 1, wherein the noble metal includes palladium.

4. The plastic housing as claimed in claim 1, wherein the chemical metal coating is a copper coating deposited from a copper electrolyte containing copper salt and sulfuric acid.

5. The plastic housing as claimed in claim 1, wherein the oxidized metal film is formed by oxidizing the chemical metal coating.

6. The plastic housing as claimed in claim 1, wherein the patterned ink coating includes an acid-resistant, alkali-resistant and non-conductive resin.

7. The plastic housing as claimed in claim 1, wherein the patterned ink coating is recessed relative to the electroplated metal coating.

8. A method for making a plastic housing, comprising the steps of:
providing a plastic substrate;
metalizing a surface of the plastic substrate;
passivating the metalized surface of the substrate;
printing ink onto the metalized surface of the substrate to form a patterned ink coating;
immersing the substrate into an acid solution; and
electroplating a metal coating onto the substrate.
wherein the patterned ink coating is recessed relative to the metal coating.

9. The method as claimed in claim 8, wherein the substrate is made of plastic selected from the group consisting of acrylonitrile butadiene styrene, poly methyl methacrylate, and polycarbonate.

10. The method as claimed in claim 8, wherein the metallization of the substrate is carried out using wet chemical deposition, and the method includes the steps of: roughening the surface of the substrate, activating the surface of the substrate, and chemically plating a copper coating on the surface of the substrate.

11. The method as claimed in claim 10, wherein the activation of the surface of the substrate is carried out in a solution containing hydrochloric acid, polyamide acid, and noble metal salt, a noble metal being separated out from the solution and dispersed and deposited the surface of the substrate during the activation.

12. The method as claimed in claim 11, wherein the noble metal may include palladium.

13. The method as claimed in claim 8, wherein the passivation of the metalized surface is carried out by oxidizing the metalized surface using an acid to form a oxidized metal film.

14. The method as claimed in claim 13, wherein during immersing the substrate into the acid solution, a portion of the oxidized metal film not covered by the patterned ink coating is removed from the substrate by reacting with the acid solution.

15. The method as claimed in claim 8, wherein the patterned ink coating involves an acid-resistant, alkali-resistant and non-conductive resin system.

16. The method as claimed in claim 8, wherein the metal coating formed by the electroplating includes at least one of a copper coating, a chrome coating, and a steel coating.

17. The method as claimed in claim 8, wherein the patterned ink coating is recessed relative to the metal coating formed by electroplating.
